(19) United States
(12) Patent Application Publication
(10) Pub. No.: US 2006/0011294 A1
(43) Pub. Date: Jan. 19, 2006

(54) Method for production of a laminate from metal layers and fibre reinforced plastic layers

(76) Inventor: Abdoel Faziel Rajabali, Alphen A D Rijn (NL)

Correspondence Address: GREENBERG TRAURIG LLP, 2450 COLORADO AVENUE, SUITE 400E, SANTA MONICA, CA, 90404, US

(21) Appl. No.: 10/534,278

(22) PCT Filed: Nov. 6, 2003
(86) PCT No.: PCT/NL03/00775

§ 371 Date: May 6, 2005

(30) Foreign Application Priority Data
Nov. 6, 2002 (NL) 1021860

(51) Int. Cl. B29C 70/44; B29C 65/00

(52) U.S. Cl. 156/307.7; 264/510; 264/258; 264/316; 156/285

(57) ABSTRACT

In the production of a laminare from metal layers (7) and fibre-reinforced plastic bonding layers (8) a pack (6) is formed that is placed on a forming jig (1). An evacuation medium (12) and a vacuum film (13) are placed over the pack, such that the pack can be pressed onto the forming jig under the influence of a vacuum. Finally, the layers are bonded to one another in an autoclave under the influence of heat and pressure. Especially in the case of larger workpieces, the problem arises that the various layers shift with respect to one another. This is frequently undesirable and the layers have to be held in the correct position with respect to one another. According to the invention, for this purpose a pin (4) is provided that is fixed relative to the forming jig. The various layers have holes (9), such that they can be placed on the forming jig in the correct position with respect to the pin. The evacuation medium and the vacuum film are then laid on top of the pin and the vacuum is then applied. Vacuum film and evacuation medium are then cut open, the pin is removed and the vacuum film is sealed again. During this process the vacuum remains largely intact, so that the layers remain in the correct position with respect to one another.

The invention relates to the field of the production of laminates consisting of alternating metal layers and fibre-reinforced plastic bonding layers. Such laminates are used in those fields where panels with a high strength coupled with a low weight are used. Aviation and aerospace represent an important field of application. Especially in the case of such applications, quality requirements also play a major role, in addition to strength and weight requirements. The laminates must have such a high quality that the panels produced therefrom maintain their cohesion for a prolonged period and under fluctuating conditions, such as under substantial temperature fluctuations and substantially varying loads.

A first requirement to ensure the quality of the laminates is that no damage, inaccuracies and the like creep in during the production thereof. With such a high quality process the component parts, such as the metal layers and the plastic sheets, are handled carefully and economically.

For certain operations the risk of damage and the like is relatively high. Such an increased risk arises when centring the various layers of the laminate by means of a centring pin. The centring pin is inserted in a special centring hole made in the laminate for that purpose. It is fixed on the forming jig on which the pack of alternating layers is placed.

After the layers have been bonded to one another in an autoclave, the pack formed in this way is lifted from the forming jig and during this operation is slid off the centring pin. During this operation the problem can arise that, as a result of the sliding movement of the centring pin with respect to the rim of the hole, parts of the layers do not move properly with the rest but remain caught or stick. Furthermore, adhesive can collect in the centring hole, as a result of which this effect is further exacerbated.

The aim of the invention is, therefore, to provide a method for the production of a laminate that better meets the requirements in this regard. Said aim is achieved by means of a method for the production of a laminate consisting of alternating layers of metal and fibre-reinforced plastic bonding layers, comprising the following steps:

the provision of a forming jig provided with at least one centring pin,

placing at least two metal layers with a fibre-reinforced plastic bonding layer between them on the forming jig, in which layers there is an opening through which the centring pin extends,

placing an aid on the layer around the centring pin,

applying an evacuation medium to the layers around the centring pin,

applying a vacuum film on top of the layers, the centring pin and the aid,

applying and maintaining a reduced vacuum to the layers between the forming mould and the vacuum film,

making a hole in the vacuum film and the evacuation medium at the location of the centring pin,

removing the centring pin via the hole,

sealing the hole in the vacuum film,

placing the forming jig with the layers, the aid and the blanket in an autoclave,

activating the bonding layer in the autoclave under the influence of heat and pressure,

removing the forming jig with the layers bonded to one another from the autoclave.

With the method according to the invention the centring hole is closed off at the top of the pack of layers by means of a tight fitting aid, for example in the form of a ring. The clearance between the centring pin and the covering means is less than the thickness of a metal layer.

When the centring pin is removed from the centring hole any portions dragged along with the centring pin are reliably stripped off by the ring. As a result the laminate largely retains its undisturbed shape.

The centring pin can have been fixed to the forming jig by means of a plug and socket joint as is customary. The blanket placed over the layers comprises a covering medium or “breather layer” and an outer film layer.

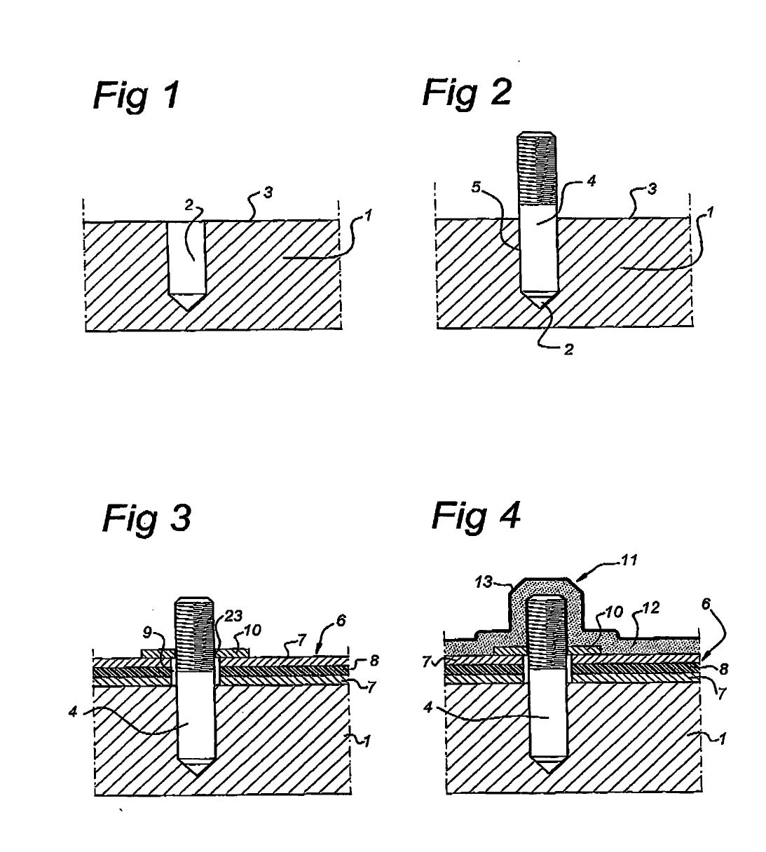

The invention will be explained in more detail below with reference to the steps in the method as shown in FIGS. 1-9.

As is shown in FIG. 1, when carrying out the method according to the invention a forming mould 1 is used in which there is at least one hole 2 for a centring pin. The surface 3 of the forming mould has the shape that the panel to be produced must acquire. As shown in the step in FIG. 2, a centring pin 4 is inserted in the centring hole 2 of the forming mould 1.

The pack consisting of metal layers 7 and a fibre-reinforced plastic bonding layer 8, which pack is indicated in its entirety by 6, is then placed on the forming jig 1. In these layers 7, 8 there are centring openings 9 in which the centring pin 4 fits with plenty of clearance.

An auxiliary ring 10, the hole 23 of which fits tightly around the centring pin 4 with little clearance; as is shown in FIG. 3, is then placed around the centring pin 4.

The blanket, which is indicated in its entirety by 11 is then placed on the top metal layer 7, the capping ring 10 and the centring pin 4, which blanket is made up of an evacuation medium in the form of a so-called breather layer 12 and a covering film 13: see FIG. 4. Under the influence of a pressure on the pack 6 generated by a reduced vacuum, the pack is fixed, as a result of which the layers (during and after the removal of the centring pin 4) do not shift with respect to one another. The pressure can be, for example, 65 kPa.

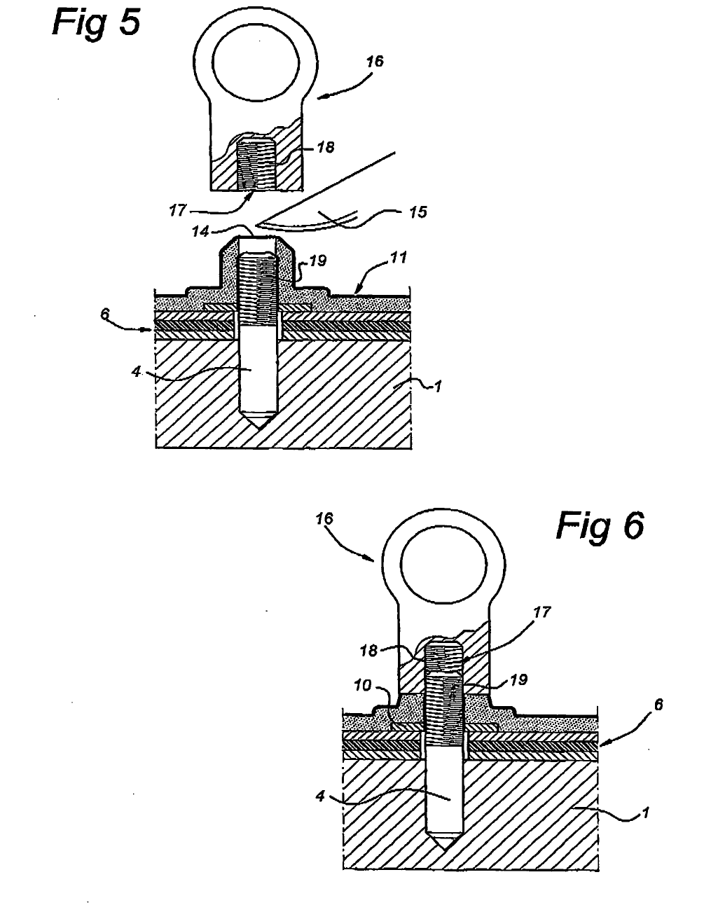

As shown in FIG. 5, the portion 14 of the blanket 11 that covers the centring pin 4 is cut open by means of a blade 15. The centring pin 4 can then be removed by means of the tool 16. The tool 16 has an opening 17 with an internal screw thread 18 that is screwed onto the exposed screw thread 19 of the centring pin 4 as shown in FIG. 6.

The tool 16 can also be connected to the centring pin 4 in some other way, such as, for example, by clamping with a spring.

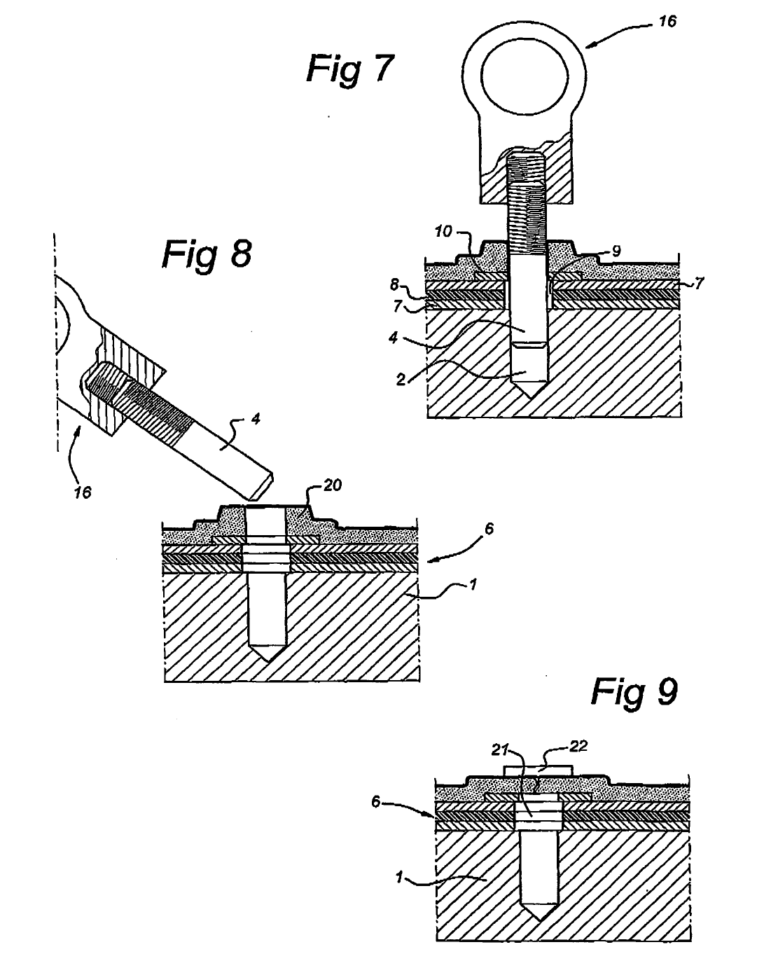

The centring pin 4 can now be pulled out of the centring hole 2 by means of the tool 16 attached in this way: see FIG. 7. During this operation the capping ring 10 ensures that the top metal layer is not also pulled upwards out of the hole and would thus bend when the centring pin is removed.

In the position shown in FIG. 8, the centring pin 4 has been completely removed by the tool 16, after which the surplus portion 20 of the blanket 11 can be cut away as shown in FIG. 9. The gap 21 formed by the removal of the centring pin is closed off by the sealing means 22 during this operation.

Despite opening the covering film 13 when cutting open the blanket 11, the vacuum can still be substantially maintained. This is because the outside air is not able to enter rapidly via the breather layer 12, as a result of which the vacuum cannot reduce substantially before the sealing means are applied.

1. Method for the production of a laminate (6) consisting of alternating layers of metal (7) and fibre-reinforced plastic bonding layers (8), comprising the following steps:
the provision of a forming jig (1) provided with at least one centring pin (4),
placing at least two metal layers (7) with a fibre-reinforced plastic bonding layer (8) between them on the forming jig (1), in which layers (7, 8) there is an opening (9) through which the centring pin (4) extends,
placing an aid (10) on the layers (7, 8) around the centring pin (4),
applying an evacuation medium (12) to the layers (7, 8) around the centring pin (4),
applying a vacuum film (13) on top of the layers (7, 8), the centring pin (4) and the aid (10),
applying and maintaining a reduced vacuum to the layers (7, 8) between the forming mould and the vacuum film (13),
making a hole in the vacuum film and the evacuation medium (12) at the location of the centring pin (4),
removing the centring pin (4) via the hole,
sealing the hole with sealing means (22),
placing the forming jig (1) with the layers (7, 8), the capping means (10) and the blanket (11) in an autoclave,
activating the bonding layer (8) in the autoclave under the influence of heat and pressure,
removing the forming jig (1) with the bonded pack (6) from the autoclave.

2. Method according to claim 1, comprising the use of an annular aid (10).

3. Method according to claim 1 or 2, wherein the centring pin (4) and the aid (10) have less clearance than the centring pin (4) and the hole (9) through the layers (7, 8).

4. Method according to one of the preceding claims, comprising fixing the centring pin on the forming jig by means of a plug and socket joint.

5. Method according to one of the preceding claims, comprising the use of a blanket consisting of a breather layer (12) and an outer film layer (13).
